(19) United States
(12) Patent Application Publication
(10) Pub. No.: US 2010/0123791 A1
(43) Pub. Date: May 20, 2010

(54) DIGITAL IMAGE PROCESSING APPARATUS AND METHOD OF CONTROLLING THE SAME

(75) Inventor: Tae-won Eom, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Digital Imaging Co., Ltd., Suwon-si (KR)

(21) Appl. No.: 12/621,653

(22) Filed: Nov. 19, 2009

(30) Foreign Application Priority Data
Nov. 19, 2008 (KR) 10-2008-0115349

(51) Int. Cl. H04N 5/228

(52) U.S. Cl. 348/222.1

(57) ABSTRACT

A digital image processing apparatus and a method of controlling the same. In the digital image processing apparatus, power is supplied to a vertical grip only when the digital image processing apparatus is held in a vertical position, thus allowing the vertical grip to operate.

### CROSS-REFERENCE TO RELATED PATENT APPLICATION

This application claims the benefit of Korean Patent Application No. 10-2008-0115349, filed on Nov. 19, 2008, in the Korean Intellectual Property Office, the entire content of which is incorporated herein by reference.

### BACKGROUND OF THE INVENTION

1. Field of the Invention

The present invention relates to a digital image processing apparatus and a method of controlling the same. More particularly, the present invention relates to a digital image processing apparatus in which a vertical grip is automatically turned on or off according to a position in which a user holds the digital image processing apparatus during photographing, thereby preventing buttons on the vertical grip from being mistakenly pressed, and a method of controlling the same.

2. Description of the Related Art

It is now easier for novice photographers to take photographs like professional photographers due to the widespread popularity of digital single lens reflex (DSLR) cameras, which are single lens reflex cameras that take digital photographs. Here, “single lens reflex” refers to a method of transmitting light of a subject to a viewfinder through a lens or transmitting the light to a sensor that can record an image. Generally, digital cameras are binocular. That is, an image that can be seen through a viewfinder of a typical digital camera is different from an image captured by the camera. Therefore, instead of using a viewfinder to compose a photograph, users generally view the image captured by a sensor, on a screen.

A conventional DSLR camera is fabricated having a mirror which is installed to revolve within a predetermined angular range about an optical axis of a lens with respect to a shaft. At ordinary times, light of a subject, which is transmitted by a lens unit, is reflected from the mirror and focused as an image on a focus plate, so that a photographer can view the image of the subject, which is focused on the focus plate, through the use of a pentaprism and a viewfinder. In this case, if a shutter-release signal is input, the mirror moves upward in order to move away from the optical axis of the lens unit while revolving within the predetermined angular range about the shaft. When a shutter is driven to be open under the control of a shutter driving circuit, the image of the subject is formed on an imaging device.

In general, a vertical grip is additionally included in such a conventional DSLR camera. The vertical grip is a device attached to the bottom of the camera in order to enable a portrait-oriented image to be taken according to a holding method ordinarily used to take a landscape-oriented image. The vertical grip may be manufactured with a camera in a single body, but is generally formed to be detachable from the body of the camera.

The vertical grip additionally includes a shutter-release button, an AF-LOCK button, a zoom button, an exposure control dial, and so on, so that a portrait-oriented image may be taken according to a holding method ordinarily used to take a landscape-oriented image. When a user captures an image by holding a camera in the vertical position, use of the vertical grip allows the user to easily handle the camera while comfortably holding the camera. Also, an additional battery or a memory may be mounted in the vertical grip.

However, in general, while a DSLR camera attached with a conventional vertical grip is in use, the vertical grip is continuously turned on even when the vertical grip is not used. Thus, since the vertical grip is continuously turned on even when photographing is performed while holding the camera in a normal position as illustrated in FIG. 1, one of the buttons (e.g., 211, 212 or 213) on the vertical grip 200 may be mistakenly pressed by a body part of a user, for example, a hand, thus causing the camera to perform an undesired function.

### SUMMARY OF THE INVENTION

The present invention provides a digital image processing apparatus in which a vertical grip is automatically turned on or off according to a position in which a user holds the digital image processing apparatus during photographing, thereby preventing buttons on the vertical grip from being mistakenly pressed, and a method of controlling the same.

Accordingly, an embodiment of the present invention provides a digital image processing apparatus having a vertical grip, in which the vertical grip is turned on only when the digital image processing apparatus is held in a vertical position. The apparatus comprises a position sensing unit which determines whether the digital image processing apparatus is held in the vertical position, and a digital signal processor which controls the position sensing unit, and controlling power to be supplied to the vertical grip when the position sensing unit determines that the digital image processing apparatus is held in the vertical position. The position sensing unit can comprise at least one of a rotation sensor and a Gyro sensor. Accordingly, only when the digital image processing apparatus is held in the vertical position and the vertical grip power switch is turned on, is power supplied to the vertical grip. In addition, when the digital image processing apparatus is held in the vertical position, a shutter-release button mounted on the digital image processing apparatus is prevented from being pressed.

Another embodiment of the present invention provides a method of controlling a digital image processing apparatus having a vertical grip. The method comprises determining whether the digital image processing apparatus is held in a vertical position, and supplying power to the vertical grip only when it is determined that the digital image processing apparatus is held in the vertical position. The method further comprises determining whether the vertical grip is turned on, and only when the digital image processing apparatus is held in the vertical position and the vertical grip is turned on, is power supplied to the vertical grip. The process of determining of whether the digital image processing apparatus is held in the vertical position is performed using a rotation sensor or a Gyro sensor. The method further prevents a shutter release button on the digital image processing apparatus from being pressed if it is determined that the digital image processing apparatus is held in the vertical position.

A further embodiment of the present invention provides a system for use with a digital image processing apparatus, comprising a sensor which determines whether the digital image processing apparatus is held in a vertical position, and a processor which receives signals from the sensor indicating whether the digital image processing apparatus is held in a vertical position, and outputs a power signal for turning on a vertical grip coupled to the digital image processing apparatus only when the digital image processing apparatus is held in a vertical position. The sensor comprises at least one of a rotation sensor and a Gyro sensor. Also, only when the digital image processing apparatus is held in the vertical position and the vertical grip power switch is turned on, does the processor supply power to the vertical grip. In addition, when the digital image processing apparatus is held in the vertical position, the processor prevents a shutter-release button mounted on the digital image processing apparatus from being pressed.

### BRIEF DESCRIPTION OF THE DRAWINGS

The above and other features and advantages of the present invention will become more apparent by describing in detail exemplary embodiments thereof with reference to the attached drawings in which:

FIG. 1 is a front view of an example of a digital image processing apparatus and a vertical grip according to an embodiment of the present invention;

FIG. 2 is a rear view of the digital image processing apparatus and a vertical grip of FIG. 1 according to an embodiment of the present invention;

FIG. 3 is an exemplary block diagram of the digital image processing apparatus and a vertical grip of FIGS. 1 and 2 according to an embodiment of the present invention; and

FIG. 4 is a flowchart illustrating an example of a method of controlling a digital image processing apparatus according to an embodiment of the present invention.

### DETAILED DESCRIPTION OF THE EMBODIMENTS

Exemplary embodiments of the present invention will now be described in detail with reference to the attached drawings.

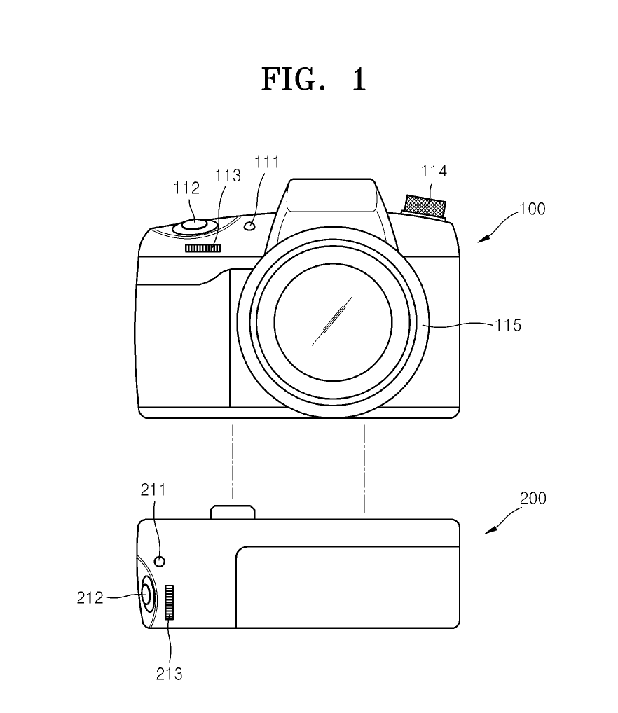

FIG. 1 is a front view of a digital image processing apparatus 100 and a vertical grip 200 installed thereon according to an embodiment of the present invention. Referring to FIG. 1, a first power button 111, a first shutter-release button 112, a first exposure control dial 113, a mode dial 114, and a lens unit 110 are installed on a front surface of the digital image processing apparatus 100. The first power button 111 is pressed to supply power to the digital image processing apparatus 100 so that the digital image processing apparatus 100 can operate. The first shutter-release button 112 opens and closes a shutter to allow an image-obtaining element, e.g., a charge-coupled device (CCD) or a complementary metal oxide semiconductor (CMOS), to be exposed to or blocked from light for a predetermined time. The first shutter-release button 112 also operates along with an aperture (not shown) to appropriately expose a subject so as to record an image of the subject in the image-obtaining element.

The first shutter-release button 112 is used to generate first and second image photographing signals. If the first image photographing signal is generated when the first shutter-release button 112 is in a half depressed state, the digital image processing apparatus 100 controls focusing and an amount of light (exposure amount) on a focal point. If adjusting of the focal point and controlling of the amount of the light are completed following the input of the first image photographing signal, the second image photographing signal which is generated when the first shutter-release button 112 is fully depressed may be input to capture an image. The first exposure control dial 113 is used to adjust a value of the shutter of the aperture of the digital image processing apparatus 100.

The mode dial 114 is pressed to select a photographing mode. The mode dial 114 supports an auto (auto photographing) mode, a scene mode, an effect mode, an A/S/M mode, etc. The auto mode is used to minimize setup requirements of a user and rapidly and conveniently capture an image according to the intention of the user. The scene mode is used to simply and optimally set a camera according to photographing conditions or conditions of a subject. The effect mode is used to give a special effect to image photographing, for example, effects such as continuous photographing, scene photographing, etc. The A/S/M mode is used to manually set various functions including the diameter of an aperture and a shutter speed to capture an image. However, the present invention is not limited to this arrangement.

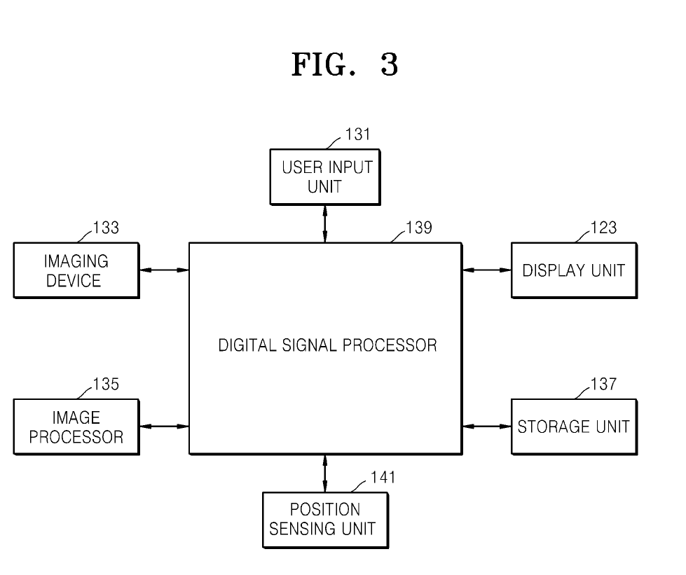

Referring to FIG. 1, a second power button 211, a second shutter-release button 212 and a second exposure control dial 213 are installed on the front surface of the vertical grip 200. The function of the second power button 211 is the same as that of the first power button 111. The function of the second shutter-release button 212 is the same as that of the first shutter-release button 112. The function of the second exposure control dial 213 is the same as that of the first exposure control dial 113. The operations of the digital image processing apparatus 100 and the vertical grip 200 will be described in detail later with reference to FIG. 3.

Although FIG. 1 illustrates that the digital image processing apparatus 100 and the vertical grip 200 are separate elements that can be combined with each other, the embodiments of the present invention are not limited to this arrangement, and the digital image processing apparatus 100 and the vertical grip 200 may be manufactured in a single body.

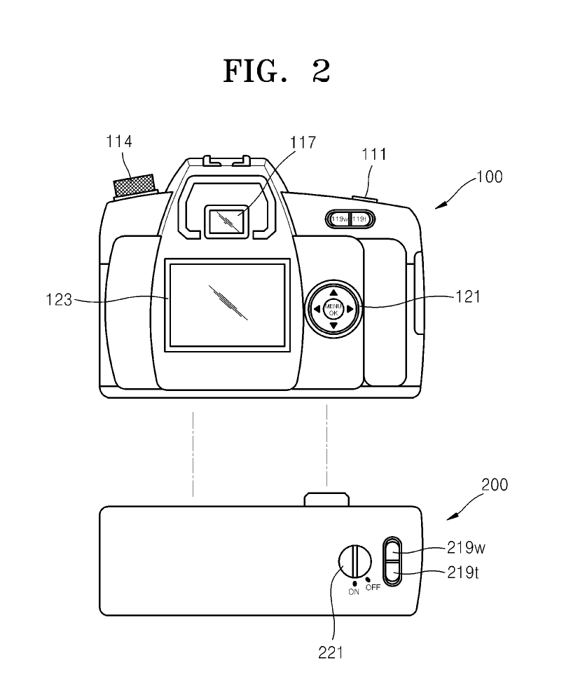

FIG. 2 is a rear view of the digital image processing apparatus 100 and the vertical grip 200 of FIG. 1 according to an embodiment of the present invention. Referring to FIG. 2, a viewfinder 117, a first wide angle-zoom button 119w, a first telephoto-zoom button 119t, a function button 121, and a display unit 123 are installed on a rear surface of the DSLR camera 100.

The viewfinder 117 is a small display screen through which a composition of a subject that is to be photographed can be viewed. The first wide angle-zoom button 119w and the first telephoto-zoom button 119t are respectively pressed to widen or narrow a viewing angle, and in particular, may be pressed to change the size of a selected exposed area. When the first wide angle zoom-button 119w is pressed, the size of the selected exposed area is increased. When the first telephoto-zoom button 119t is pressed, the size of the selected exposed area is decreased.

The function button unit 121 includes up, down, left, right, and MENU/OK buttons, i.e., a total of five buttons. The function button 121 is pressed to navigate through various menus related to operations of the digital image processing apparatus 100. The up, down, left, right, and MENU/OK buttons may be used as shortcut keys. The functions of the function button unit 121 may vary according to manufacturers.

Referring to FIG. 2, a second wide angle-zoom button 219w and a second telephoto-zoom button 219t are installed on the rear surface of the vertical grip 200. The functions of the second wide angle-zoom button 219w and the second telephoto-zoom button 219t are respectively the same as those of the first wide angle-zoom button 119w and the first telephoto-zoom button 119t.

A vertical grip power switch 221 is further installed on the rear surface of the vertical grip 200. The vertical grip power switch 221 is used to supply power to the vertical grip 200 so that the vertical grip can operate.

FIG. 3 is an exemplary block diagram of the digital image processing apparatus 100 and vertical grip 200 illustrated in FIGS. 1 and 2 according to an embodiment of the present invention. Referring to FIG. 3, the digital image processing apparatus 100 includes a display unit 123, a user input unit 131, an imaging device 133, an image processor 135, a storage unit 137, a digital signal processor 139, and a position sensing unit 141.

The user input unit 131 may include the first and second shutter-release buttons 112 and 212, the first and second power buttons 111 and 211, the first and second wide angle-zoom buttons 119w and 219w, the first and second telephoto-zoom buttons 119t and 219t, and the function button unit 121. The first and second shutter-release buttons 112 and 212 open and close a shutter to allow an imaging device or film be exposed to or blocked from light for a predetermined time. The first and second power buttons 111 and 211 are pressed to supply power to the digital image processing apparatus 100. The first and second wide angle-zoom buttons 119w and 219w are pressed to widen a viewing angle. The first and second telephoto-zoom buttons 119t and 219t are pressed to narrow the viewing angle. The function button unit 121 is installed around the display unit 123 for setting characters or a menu.

Although not shown in FIG. 3, the imaging unit 133 includes a shutter, a lens unit, an aperture, an imaging device, and an analog-to-digital converter (ADC). The shutter is a device that controls the amount of light (exposure amount) together with the aperture. The amount of light is controlled according to an opening degree of the aperture. The degree of the opening degree of the aperture is controlled by the digital signal processor 139.

The imaging device accumulates the amount of light received via the lens unit, and outputs an image formed on the lens unit according to the accumulated amount of light, in response to a vertical synchronization signal. In the digital image processing apparatus, an image is captured by the imaging device that converts light of a subject into an electrical signal. In order to obtain a color image by using the imaging device, color filters are needed, and in general, a color filter array (CFA) (not shown) is used. The CFA allows light having only one color to pass through for each of pixels, and has a structure in which a plurality of color filters are arranged according to a predetermined rule. The shape of the CFA may vary according to a manner in which color filters are arranged. The ADC converts an analog image signal received from the imaging device into a digital signal.

The image processor 135 performs signal processing on the result of digitally converting raw data so that an image corresponding to the raw data can be displayed. The image processor 135 removes a black level caused by dark current generated in the imaging device and the CFA, which are sensitive to a change in temperature. The image processor 135 performs gamma correction to encode an image according to the nonlinearity of human vision. The image processor 135 performs CFA interpolation to interpolate a Bayer pattern embodied as an RGRG line and a GBGB line of gamma-corrected predetermined data into an RGB line. The image processor 135 converts interpolated R, G, B signals to Y, U, V signals, performs edge compensation in which the Y signal is filtered using a high-pass filter to improve the definition of an image, performs color correction in which color values of the U and V signals are corrected using a standard color coordinates system, and removes noise from the Y, U, V signals. The image processor 135 creates a JPEG file by compressing and processing the Y, U, V signals from which noise is removed. The created JPEG file is displayed on the display unit 123 and is stored in the storage unit 137. All the operations of the image processor 135 are controlled by the digital signal processor 139.

The position sensing unit 141 determines whether the digital image processing apparatus 100 is held in the vertical position, under control of the digital signal processor 139. The position sensing unit 141 determines whether the digital image processing apparatus 100 is held in the vertical position and transmits the determination result to the digital signal processor 139. In general, the index finger of the user is placed near the first shutter-release button 112 when a user holds the digital image processing apparatus 100 in a normal position as illustrated in FIG. 1 but is placed near the second release-shutter 212 when the user holds the digital image processing apparatus 100 in the vertical position.

The position sensing unit 141 may be a rotation sensor or a Gyro sensor capable of sensing whether the digital image processing apparatus 100 is rotated. The Gyro sensor senses angular velocity over time (e.g., a variation in an angle over a period of one second). The Gyro sensor senses angular velocity according to the physical phenomenon that when a moving object is rotated, the Coriolis force is applied to the object in a direction perpendicular to the direction in which the object moves. In general, an analog signal is output from the Gyro sensor. The analog signal is converted into a digital signal by an ADC and is then processed by a controller. It is possible to calculate the angle by integrating the angular velocity sensed by the controller.

The digital signal processor 139 receives the orientation of the digital image processing apparatus 100 sensed by the position sensing unit 141, and determines whether power is to be supplied to a vertical grip, such as the vertical grip 200 of FIG. 1, based on the orientation of the digital image processing apparatus 100.

More specifically, the vertical grip is an auxiliary device coupled to the bottom of a digital image processing apparatus in order to enable a portrait-oriented image to be taken according to a holding method ordinarily used to take a landscape-oriented picture. The vertical grip includes a set of various buttons for the digital image processing apparatus, thus enabling a portrait-oriented image to be taken according to a holding method ordinarily used to take a landscape-oriented image. However, while a DSLR camera attached with a conventional vertical grip is in use, the vertical grip is continuously turned on even when the vertical grip is not used. Thus, since the vertical grip is continuously turned on even when photographing is performed while holding the camera in the normal position, one of the buttons on the vertical grip may be mistakenly pressed by a body part of a user, e.g., a hand, thus causing the camera to perform an undesired function.

In order to solve this problem, according to an embodiment of the present invention, power is supplied to the vertical grip 200 illustrated in FIG. 1 only when the digital image processing apparatus 100 is held in the vertical position.

The digital signal processor 139 controls supply of power to the vertical grip 200 to be discontinued when the position sensing unit 141 determines that the digital image processing apparatus 100 is not held in the vertical position, and controls power to be supplied to the vertical grip 200 when the digital image processing apparatus 100 is held in the vertical position. Also, the digital signal processor 139 may further determine whether the vertical grip power switch 221 of FIG. 2 is turned on. That is, if the digital image processing apparatus 100 is held in the vertical position, the digital signal processor 139 determines whether the vertical grip power switch 221 is turned on so that power may be supplied to the vertical grip 200 only when the vertical grip power switch 221 is turned on.

If the digital image processing apparatus 100 is held in the vertical position, the digital signal processor 139 may lock the first power button 111, the first shutter-release button 112, and the first exposure control dial 113 illustrated in FIG. 1 while power is supplied to the vertical grip 200.

Accordingly, a vertical grip is automatically turned on or off according to a position in which a digital image processing apparatus is held, thereby preventing buttons on the vertical grip from being mistakenly pressed. Furthermore, since the vertical grip is not in use, the vertical grip is automatically turned off, and thus, battery lifetime can be increased.

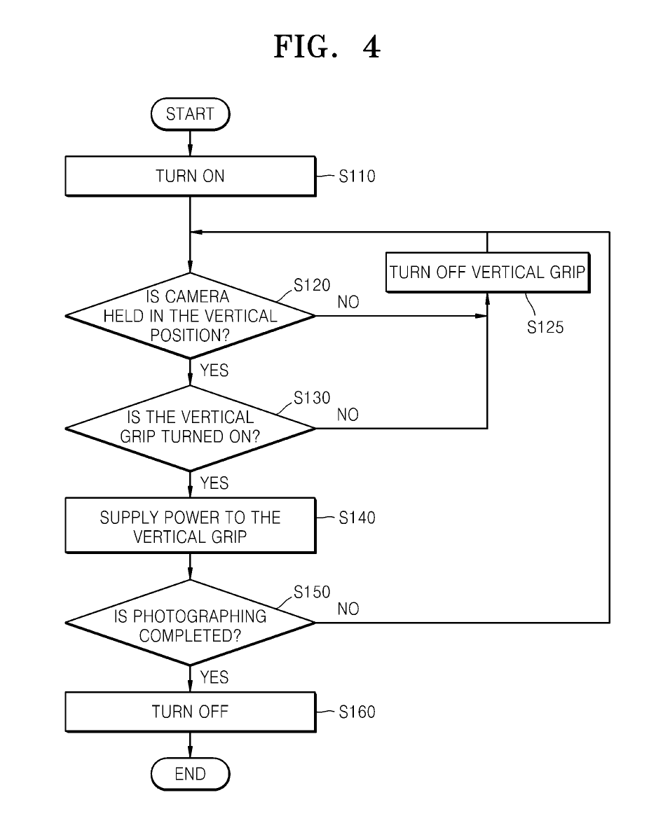

An example of a method of processing a digital image according to an embodiment of the present invention will now be described in detail with reference to FIG. 4. The method according to the current embodiment may be performed in a digital image processing apparatus as illustrated in FIG. 3. According to an embodiment of the present invention, a main algorithm of the method may be performed in the digital signal processor 139 of FIG. 3 by using peripheral devices of the digital image processing apparatus.

Referring to FIG. 4, the method includes powering on the digital image processing apparatus (operation S110), determining whether the digital image processing apparatus is held in the vertical position (operation S120), determining whether a vertical grip power switch is turned on (operation S130), supplying power to the vertical grip when the digital image processing apparatus is held in the vertical position and the vertical grip power switch is turned on (operation S140), determining whether photographing is completed (operation S150), and powering off the digital image processing apparatus when the photographing is completed (operation S160). More specifically, first, the digital image processing apparatus is turned on (operation S110), and it is determined whether the digital image processing apparatus is held in the vertical position (operation S120). A rotation sensor or a Gyro sensor capable of sensing whether the digital image processing apparatus is rotated may be used in order to determine whether the digital image processing apparatus is held in the vertical position.

If it is determined that the digital image processing apparatus is not held in the vertical position, supply of power to the vertical grip is discontinued (operation S125). If it is determined that the digital image processing apparatus is held in the vertical position, it is determined whether the vertical grip power switch is turned on (operation S130).

If it is determined that the vertical grip power switch is turned off, supply of power to the vertical grip is discontinued (operation S125). If it is determined that the vertical grip power switch is turned on, power is supplied to the vertical grip (operation S140).

Although FIG. 4 illustrates that it is determined whether the digital image processing apparatus is held in the vertical position and it is determined whether the vertical grip power switch is turned on only when the digital image processing apparatus is held in the vertical position, the embodiments of the present invention are not limited to this arrangement. That is, whether the vertical grip power switch is turned on may first be determined, and then, whether the digital image processing apparatus is held in the vertical position may be determined only when the vertical grip power switch is turned on.

Also, the method may further include locking the first power button 111, the first shutter-release button 112, and the first exposure control dial 113 illustrated in FIG. 1 of the digital image processing apparatus which are respectively related to buttons on the vertical grip while power is supplied to the vertical grip (operation S140), when the digital image processing apparatus is held in the vertical position and the vertical grip power switch is turned on. Lastly, it is determined whether photographing is completed (operation S150), and operations S110 to S140 are performed again when it is determined that the photographing is not completed.

According to the above embodiments of the present invention, a vertical grip is turned on or off according to a position in which a digital image processing apparatus is held, thereby preventing buttons on the vertical grip from being mistakenly pressed. Furthermore, when the vertical grip is not in use, the vertical grip is automatically turned off, thereby increasing the lifetime of battery.

While this invention has been particularly shown and described with reference to exemplary embodiments thereof, it will be understood by those of ordinary skill in the art that various changes in form and details may be made therein without departing from the spirit and scope of the invention as defined by the appended claims. The above exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A digital image processing apparatus having a vertical grip, in which the vertical grip is turned on only when the digital image processing apparatus is held in a vertical position.

2. The apparatus of claim 1, comprising:
a position sensing unit which determines whether the digital image processing apparatus is held in the vertical position; and
a digital signal processor which controls the position sensing unit, and controlling power to be supplied to the vertical grip when the position sensing unit determines that the digital image processing apparatus is held in the vertical position.

3. The apparatus of claim 2, wherein the position sensing unit comprises at least one of a rotation sensor and a Gyro sensor.

4. The apparatus of claim 1, wherein only when the digital image processing apparatus is held in the vertical position and the vertical grip power switch is turned on, is power supplied to the vertical grip.

5. The apparatus of claim 1, wherein, when the digital image processing apparatus is held in the vertical position, a shutter-release button mounted on the digital image processing apparatus is prevented from being pressed.

6. A method of controlling a digital image processing apparatus having a vertical grip, the method comprising:
determining whether the digital image processing apparatus is held in a vertical position; and
supplying power to the vertical grip only when it is determined that the digital image processing apparatus is held in the vertical position.

7. The method of claim 6, further comprising determining whether the vertical grip is turned on,
wherein only when the digital image processing apparatus is held in the vertical position and the vertical grip is turned on, is power supplied to the vertical grip.

8. The method of claim 6, wherein the determining of whether the digital image processing apparatus is held in the vertical position is performed using a rotation sensor or a Gyro sensor.

9. The method of claim 6, further comprising preventing a shutter release button on the digital image processing apparatus from being pressed if it is determined that the digital image processing apparatus is held in the vertical position.

10. The method of claim 6, wherein:
the determining of whether the digital image processing apparatus is held in the vertical position is performed using a position sensing unit which determines whether the digital image processing apparatus is held in the vertical position; and
the supplying power to the vertical grip is performed using a digital signal processor which controls the position sensing unit and controls power to be supplied to the vertical grip when the position sensing unit determines that the digital image processing apparatus is held in the vertical position.

11. A system for use with a digital image processing apparatus, the system comprising:
a sensor which determines whether the digital image processing apparatus is held in a vertical position; and
a processor which receives signals from the sensor indicating whether the digital image processing apparatus is held in a vertical position, and outputs a power signal for turning on a vertical grip coupled to the digital image processing apparatus only when the digital image processing apparatus is held in a vertical position

12. The system of claim 11, wherein the sensor comprises at least one of a rotation sensor and a Gyro sensor.

13. The system of claim 11, wherein only when the digital image processing apparatus is held in the vertical position and the vertical grip power switch is turned on, does the processor supply power to the vertical grip.

14. The system of claim 11, wherein, when the digital image processing apparatus is held in the vertical position, the processor prevents a shutter-release button mounted on the digital image processing apparatus from being pressed.
